(19) United States
(12) Patent Application Publication
(10) Pub. No.: US 2017/0331344 A1
(43) Pub. Date: Nov. 16, 2017

(54) MODULE FOR COOLING HEATING ELEMENT AND MOTOR INCLUDING SAME

(71) Applicant: POSCO, Pohang-si, Gyeongsangbuk-do (KR)

(72) Inventors: Young-Ju KANG, Seoul (KR); Jae-Hong KIM, Seoul (KR); You-Mee KIM, Seoul (KR); In-Sool RYU, Seoul (KR); Byung-Jin KIM, Seoul (KR)

(21) Appl. No.: 15/526,215

(22) PCT Filed: Nov. 12, 2015
(86) PCT No.: PCT/KR2015/012184

§ 371 Date: May 11, 2017

(30) Foreign Application Priority Data
Nov. 12, 2014 (KR) 10-2014-0157188

(51) Int. Cl. H02K 5/20; H02K 9/197; F28D 15/04; H02K 9/20

(52) U.S. Cl. CPC H02K 5/20; H02K 9/197; F28D 15/046; H02K 9/20

(57) ABSTRACT

The present invention relates to a module for cooling a heating element and a motor including the same. The module for cooling the heating element, according to the present invention, can comprise: a flat plate-shaped heat pipe containing working fluid therein, coming into close contact with the heating element, and including a condensation region which does not come into contact with the heating element; and a cooling channel connected to the condensation region, and cooling the heat pipe by a refrigerant.

### TECHNICAL FIELD

The present disclosure relates to a module for cooling a heating element and a motor including the same, and more particularly, to a module for cooling a heating element, cooling a heating element using a heat pipe, and a motor including the same.

### BACKGROUND ART

In general, motors are devices converting electrical energy into mechanical energy, thus obtaining rotational force. Motors are widely used for industrial devices and the like, as well as in home electrical appliances. Motors are largely divided into direct current (DC) motors and alternating current (AC) motors.

In the case of DC motors, motors with brushes have a function of allowing current to flow in coils and simultaneously rectifying current through contact between commutators and brushes, while having negative properties in which brushes may be worn. In order to reduce such disadvantages, brushless DC (BLDC) motors, not employing brushes therein, have been known. Such BLDC motors have been extensively used due to high torque, excellent controllability, and speed.

However, in related art motors as described above, high temperatures may be generated in the vicinity of rotors and coils inside the motors when the motors are driven, thereby damaging internal components of motors and causing energy loss due to heat generation.

Further, the lifespans of motors may be shortened and the efficiency thereof may be lowered due to reductions in magnetic force through heat acting on magnets inside the motors. In particular, in the case of small-sized motors (less than 200 W), since a relatively high amount of heat may be generated therein, such small sized motors may not be realized without solving the problem of excessive heat.

Furthermore, large objects, such as electric vehicles, fuel cell vehicles and hybrid vehicles, also require motors. Since motors used in such large objects also generate large amounts of heat, cooling may be an important issue.

A motor housing 2 of a motor 1 of the related art illustrated in FIG. 1 is formed to have a cylindrical shape surrounding internal components in the outside thereof. A rotating shaft 8 disposed in a vertical direction, a stator 5 and a rotor 7 as means by which electric energy is converted into rotational force, are accommodated in the motor housing 2.

The stator 5 is a stator supported inside the motor housing 2, and a coil 4 is wound around the stator 5 a plurality of times. The stator 5 is formed to have a cylindrical shape so that the rotor 7 may be received therein. An insulator 3 is interposed between an inner peripheral surface of the motor housing 2 and the coil 4 so as not to conduct electricity.

As a general method of cooling the motor as described above, a method in which a cooling pipe 10 is wound around an outer side of a housing of a motor 1 and cooling water flows in the cooling pipe is illustrated in FIG. 2.

However, such a method has a problem in that it may be difficult to wind the cooling pipe 10 around an outer side of a cylindrical motor and it may be very difficult to form an appropriate cooling channel using the cooling pipe 10.

In addition, in terms of shape characteristics of the cooling pipe 10, there is a disadvantage in that it may be difficult to adhere to a cylindrical motor, and this disadvantage leads to a problem of reduced cooling efficiency.

Further, even in a case in which cooling of the motor is attempted by flowing cooling water through the cooling pipe 10, it may be difficult to flow the cooling water through the cooling pipe 10 having a complicated shape, and it may be difficult to control a temperature of the cooling water and the motor.

### DISCLOSURE

### Technical Problem

In order to solve the problems as described above, an aspect of the present disclosure is to provide a module for cooling a heating element, having improved cooling efficiency, and a motor including the same.

In detail, an aspect of the present disclosure is to provide a cooling module, in which energy consumed during cooling may be reduced by simplifying a flow path, and management thereof may be simplified.

In addition, an aspect of the present disclosure is to provide a motor having improved driving efficiency by performing efficient cooling, thereby increasing a lifespan of a motor.

Furthermore, an aspect of the present disclosure is to provide a cooling module having a simple structure to be compatibly applied to various types of heating elements as well as to motors.

### Technical Solution

According to an aspect of the present disclosure, a module for cooling a heating element, and a motor including the same are provided.

First, according to an aspect of the present disclosure, a module for cooling a heating element includes: a heat pipe having a flat plate shape, including a working fluid therein, coming into close contact with a heating element, and including a condensation region not coming into contact with the heating element; and a cooling channel connected to the condensation region, and cooling the heat pipe by a refrigerant.

The cooling channel may be installed not to be in contact with the heating element, to be connected to the heat pipe, in the cooling region.

The heat pipe and the heating element may be provided with a heat transfer material interposed therebetween.

The module for cooling a heating element may further include a housing surrounding an outer surface of the heating element. The heat pipe may be disposed between the housing and the heating element to be closely adhered to the heating element.

According to an aspect of the present disclosure, a module for cooling a heating element includes a heat pipe having a flat plate shape, including a working fluid therein, and mounted on a heating element in such a manner that a condensation region being in non-contact with the heating element is located in a direction of gravity; and a cooling channel connected to the condensation region and cooling the heat pipe using a refrigerant.

The module for cooling a heating element may further include a plurality of side cooling channels disposed on an outer surface of the heating element in a direction perpendicular with respect to the cooling channel.

The cooling channel may be provided as a water jacket including a supply passage and a discharge passage, and the module for cooling a heating element may further include an auxiliary cooling channel connected to the water jacket to perform heat exchange with the refrigerant.

According to an aspect of the present disclosure, a module for cooling a heating element includes a heat pipe having a flat plate shape, including a working fluid therein, being in contact with a heating element, and including a condensation region not in contact with the heating element; a plurality of cooling fins installed on the heat pipe; and a cooling fan supplying cooling gas to the cooling fins and the condensation region.

According to an aspect of the present disclosure, a module for cooling a heating element includes a housing enclosing an outer surface of a heating element; a heat pipe having a flat plate shape, including a working fluid therein, disposed between the housing and the heating element to be in contact with the heating element, and including a condensation region not in contact with the heating element; a cooling fan supplying cooling gas to the condensation region; and a plurality of cooling fins installed in the condensation region. The cooling pins are cooled by air.

The heat pipe may have an appearance of a shape including at least one or more corners, and may have an interior provided as a hollow portion in which the working fluid is circulated.

The cooling channel may be connected to the heat pipe therein, and a refrigerant provided therein may be in direct contact with the heat pipe.

The heat pipe may have a curved inner wall.

The module for cooling a heating element may further include a cover housing surrounding an outer side of the heat pipe, and a plurality of the heat pipes may be stacked on an outer side of the cover housing.

The housing may have a polygonal shape, and a plurality of the heat pipes may be stacked on an outer side of the housing.

The auxiliary cooling channel may include a radiator having an inlet and an outlet, the inlet of the radiator being connected to the discharge passage to perform heat exchange with the refrigerant; and a water pump connected to the outlet of the radiator and connected to the supply passage.

According to an aspect of the present disclosure, a module for cooling a heating element includes a hollow portion provided in a hollow form of which an entrance is closed, and accommodating a working fluid therein; and a cooling channel connected to the heating element and cooling the heating element by a refrigerant. The hollow portion is provided as a heat pipe.

The working fluid may be provided as any one of water, acetone, methanol, ethanol, Freon, ammonia, and R134, and an interior of the heat pipe may be maintained at 1 atm or lower.

The heat pipe may be formed of any one of aluminum, iron, copper, stainless steel, zinc, bronze and brass, or a mixture thereof.

The working fluid may be provided as any one of water, acetone, methanol, ethanol, Freon, ammonia, and R134, and an interior of the heat pipe may be maintained at 1 atm or lower.

According to an aspect of the present disclosure, a motor includes a motor housing; a rotating shaft, a rotor, a stator and a permanent magnet provided in the motor housing; and the module for cooling a heating element described above. The heating element may be the motor housing.

### Advantageous Effects

According to an exemplary embodiment, a cooling module having improved cooling efficiency and ease in controlling may be provided.

In addition, energy consumed for cooling may be reduced to decrease maintenance costs, and costs of constructing a cooling module may be decreased due to a simple structure and easy processing.

In the case of a motor equipped with such a cooling module, since driving efficiency may be increased and a lifespan thereof may be prolonged, material costs may be reduced.

### DESCRIPTION OF DRAWINGS

FIG. 1 is a schematic view illustrating an internal structure of a general motor.

FIG. 2 is a schematic view illustrating a combination of a normal motor and a cooling pipe.

FIG. 3 is a schematic view illustrating an internal structure of a heat pipe according to an exemplary embodiment in the present disclosure.

FIG. 4 is a schematic view of a module for cooling a heating element according to an exemplary embodiment in the present disclosure.

FIG. 5 is a schematic view of a cooling channel of a module for cooling a heating element according to an exemplary embodiment in the present disclosure.

FIG. 6 is a schematic view of a module for cooling a heating element according to another exemplary embodiment in the present disclosure.

FIG. 7 is a schematic view of a module for cooling a heating element according to another exemplary embodiment in the present disclosure.

FIG. 8 is a schematic view of a module for cooling a heating element according to another exemplary embodiment in the present disclosure.

FIG. 9 is a schematic view of a module for cooling a heating element according to another exemplary embodiment in the present disclosure.

FIG. 10 is a schematic view illustrating a structure of a heating element according to another exemplary embodiment in the present disclosure.

FIG. 11 is a schematic view illustrating that a heating element is cooled using a cooling fan according to another exemplary embodiment in the present disclosure.

FIG. 12 is a schematic view illustrating a structure of a heating element according to another exemplary embodiment in the present disclosure.

FIG. 13 is a schematic view of a module for cooling a heating element according to another exemplary embodiment in the present disclosure.

FIG. 14 is a schematic view illustrating a structure of a heating element according to another exemplary embodiment in the present disclosure.

FIG. 15 is a schematic view illustrating a structure of a heating element according to another exemplary embodiment in the present disclosure.

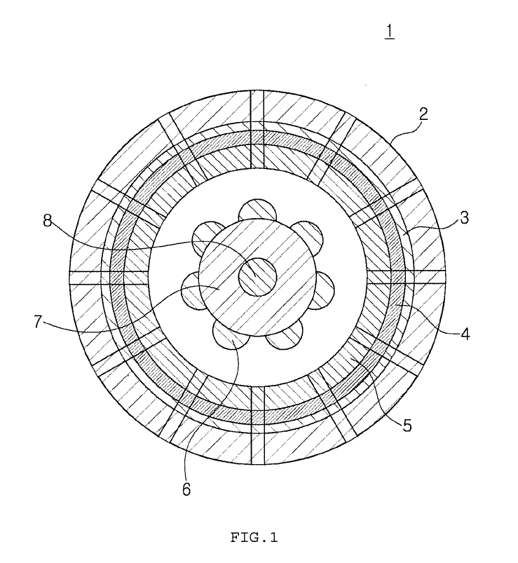

### BEST MODE

In order to facilitate an understanding of the description of exemplary embodiments in the present disclosure, elements denoted by the same reference numerals in the accompanying drawings are the same elements, and among elements performing the same function in respective exemplary embodiments, relevant elements are represented by the same or similar reference numerals.

Further, in order to clarify the gist of the present disclosure, a description of elements and techniques well known in the related art will be omitted, and exemplary embodiments in the present disclosure will be described in detail with reference to the accompanying drawings.

In addition, a heat transfer material mentioned below refers to a medium transferring energy in a movement phenomenon of heat energy, such as conduction, radiation, and convection of heat.

In addition, the present disclosure is not limited to the exemplary embodiments provided herein, but may be suggested by those skilled in the art in other forms in which specific constituent elements are added, changed or deleted, within the scope of the present invention.

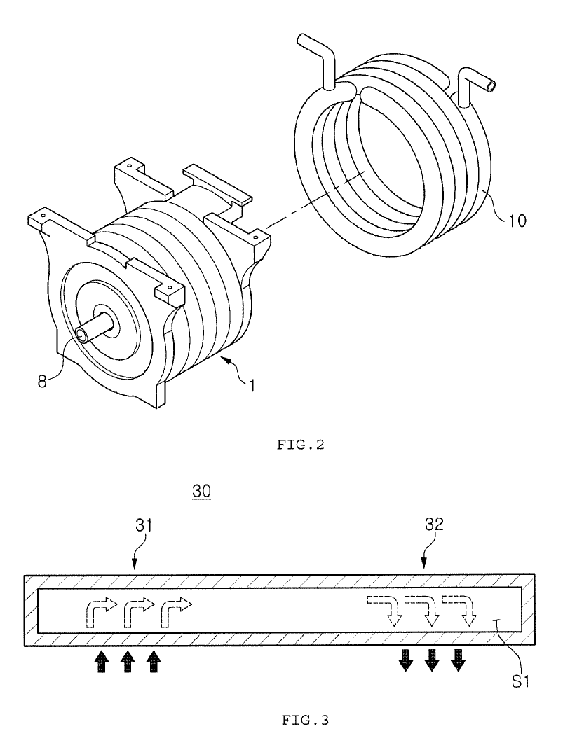

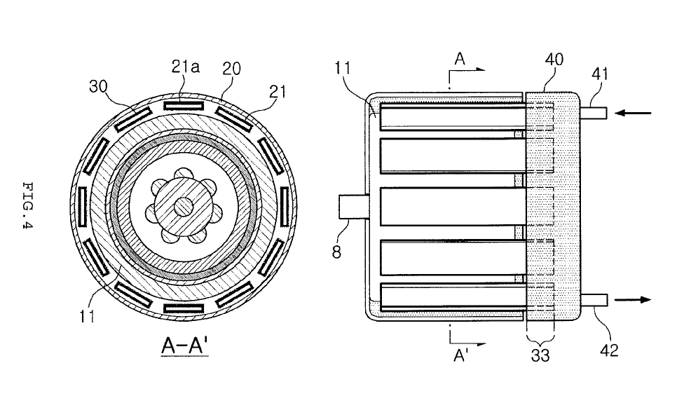

First, referring to FIG. 3, a heat pipe 30 according to an exemplary embodiment will be described. An interior of the heat pipe 30 may be hollow in a vertical direction, for example, provided with a hollow portion S1 formed therein. In the hollow portion S1, a working fluid may be circulated, and the hollow portion S1 may be maintained at 1 atm or lower so as to be near a vacuum state.

This state may be effective in that the working fluid inside the heat pipe 30 may be quickly boiled and vaporized in an evaporation portion 31 coming into contact with a heat generating portion of a heating element. For example, convection heat transfer is performed inside the heat pipe 30, in which a heat transfer rate is faster than conduction, thereby increasing a cooling rate. Then, circulation of the working fluid by a capillary phenomenon may be generated in the hollow portion S1 of the heat pipe in which the working fluid is present.

Thus, the working fluid, having moved from the evaporation portion 31 of the heat pipe 30 to a condensation portion 32 thereof, may be subjected to a cooling process to be described below, and then, may be returned to the evaporation portion 31.

In detail, the working fluid may be provided as any one of water, acetone, methanol, ethanol, Freon, ammonia, and refrigerant gas R134. In further detail, when a temperature of the heating element is in a low-temperature section, R134 may be used as the working fluid.

In a case in which the heat pipe 30 is installed in the heating element and a temperature is measured, when the temperature in the evaporation portion 31 is about 80° C. on average and the temperature in the condensation portion 32 does not go much beyond about 50° C. on average, any one of water, acetone, methanol, ethanol, Freon, ammonia, and refrigerant gas R134 may be used as the working fluid.

On the other hand, when the temperature is relatively low, for example, the temperature in the evaporation portion is about 0° C. on average and the temperature in the condensation portion 32 is about 30° C. on average, using R134 as the working fluid may be relatively effective. R134 may perform a function of the working fluid without difficulty, even in a relatively low temperature range, and unlike Freon, the working fluid may not cause environmental pollution.

With reference to such matters, an operator may perform relatively quick and efficient cooling by selecting an optimum working fluid according to heating characteristics of the heating element, but the present disclosure is not limited thereto.

A shape of the heat pipe 30 may be a shape including at least one corner. For example, an exemplary embodiment in the present disclosure may provide a quadrangular heat pipe. The quadrangular heat pipe may have a larger contact area than that of a cylindrical heat pipe when contacting with a circular heating element. Thus, in an exemplary embodiment, a relatively thin, quadrangular flat plate-shaped heat pipe may be provided to easily contact a heating element.

In detail, the heat pipe 30 may be formed to have a rectangular shape having a thickness of 0.1 mm to 10 mm and a width of 0.5 cm to 100 cm. As a material of the heat pipe 30, aluminum, iron, copper, stainless steel, zinc, bronze or brass, having good thermal efficiency, may be used. The heat pipe 30 provided as described above may be relatively efficiently adhered to the heating element while bending flexibly.

In addition, a total length of the heat pipe 30 may be formed to be about 1 cm to 200 cm longer than a length of the heating element applied thereto. For example, when the heating element and the heat pipe are arranged in the same lengthwise direction, a region of the heat pipe 30, longer by 1 cm to 200 cm than that of the heating element in the lengthwise direction, may not be in contact with the heating element, and cooling may be performed in a section of the heat pipe 30 not in contact with the heating element, thereby improving cooling efficiency.

Further, an inner wall of the heat pipe 30 in contact with the working fluid may be formed to have a curved shape, for example, a groove structure, a wick structure, or the like, and thus, a flow of the working fluid may be actively and quickly performed.

Hereinafter, a module for cooling a heating element according to an exemplary embodiment in the present disclosure and a motor including the same will be described in detail, based on the descriptions above. It should be understood, however, that the present disclosure is not limited to the described exemplary embodiments, and various exemplary embodiments will be respectively described in detail with reference to the accompanying drawings.

### Embodiment 1

As illustrated in FIG. 4, a module for cooling a heating element according to an exemplary embodiment may include a housing 20 surrounding an outer surface of a heating element 11; and a flat plate-shaped heat pipe 30 including a working fluid therein, disposed inside the housing and being in close contact with the heating element in a vertical direction, and including a condensation region 33 not in contact with the heating element; and a water jacket 40 connected to the condensation region and provided as a cooling channel cooling the heat pipe using a refrigerant.

The heat pipe 30 may be provided as a plurality of heat pipes disposed along an outer circumference of the heating element 11. Although the heat pipe 30 may directly contact the outer circumferential surface of the heating element, a heat transfer material may also be provided together with the heat pipe. In addition, a size of the heat pipe 30 and the number of the heat pipes 30 installed may be changed according to the specifications and characteristics of the heating element 11.

Further, the water jacket 40 may include a supply passage 41 receiving cooling water, as an example of a refrigerant, and a discharge passage 42 discharging the cooling water that has undergone heat exchange with the heat pipe 30 inside the water jacket 40.

Further, the water jacket 40 may be disposed not to be in contact with the heating element 11 to be connected to the condensation region 33 of the heat pipe 30. In this case, since cooling is performed relatively far away from the heating element 11 generating a large amount of heat, cooling efficiency may be increased.

A connection between the water jacket 40 and the condensation region 33 of the heat pipe 30 may be performed by welding, or a heat transfer material having good cooling efficiency may be fully filled in such a manner that the heat pipe may be fixed within the water jacket 40 by compression. However, the present disclosure is not limited thereto.

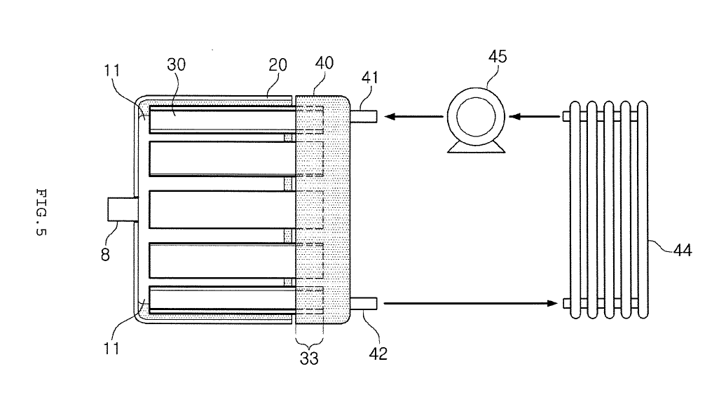

On the other hand, as illustrated in FIG. 5, the cooling channel may further include an auxiliary cooling channel connected to the water jacket 40 to exchange heat with the refrigerant in the water jacket. The auxiliary cooling channel may include a radiator 44 having an inlet and an outlet, of which the inlet is connected to the discharge passage 42, and a water pump 45 connected to the outlet of the radiator and connected to the supply passage 41 of the water jacket 40.

As a result, the refrigerant cooling the heat pipe 30 in the water jacket 40 is cooled again, and is supplied quickly and smoothly through the water pump, thereby increasing cooling efficiency.

### Embodiment 2

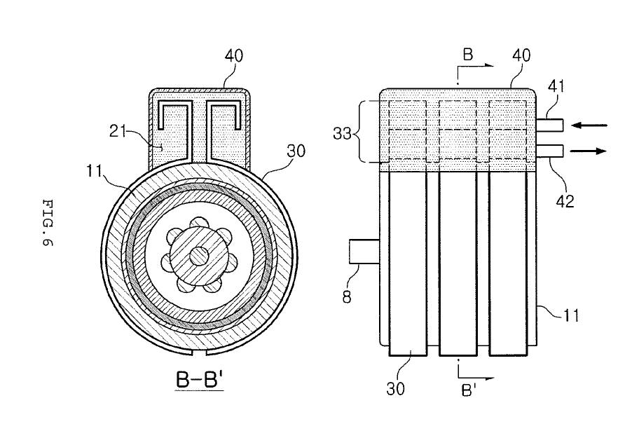

As illustrated in FIG. 6, a module for cooling a heating element according to an exemplary embodiment may include a flat plate-shaped heat pipe containing a working fluid therein, and mounted on a heating element 11 in such a manner that a condensation region 33 being in non-contact with the heating element 11 is located in a direction of gravity; and a cooling channel 40 connected to the condensation region and cooling the heat pipe using a refrigerant.

By disposing the heat pipe in the direction of gravity as described above, circulation of the working fluid inside may be performed more quickly by the gravity and the cooling speed may be further increased. Further, the condensation region 33 may be disposed on an upper portion of the heating element 11 or on a lower portion thereof.

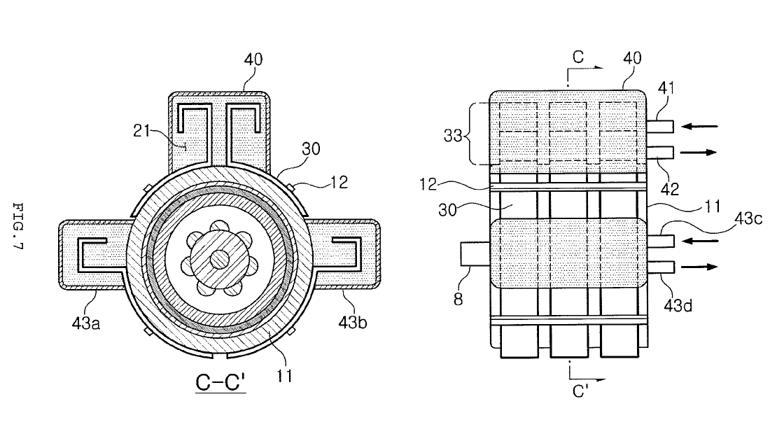

In addition, as illustrated in FIG. 7, the module for cooling a heating element according to the exemplary embodiment may further include a plurality of side cooling channels arranged on an outer surface of the heating element 11 in a direction perpendicular with respect to the cooling channel, for example, the water jacket 40. The side cooling channel may be provided as a first side cooling channel 43a disposed on one side of the heating element 11 and a second side cooling channel 43b disposed on the other side thereof, based on the water jacket 40.

On the other hand, a mounting position of the side cooling channels and the number of the side cooling channels are not limited thereto, but may be appropriately changed depending on a worker and a working environment.

In this case, for example, when a joining member 12 such as a strap is further used on an outer surface of the heat pipe 30, coupling force between the heating element 11 and the heat pipe 30 may be further increased.

As described above, in the first and second exemplary embodiments, a water-cooling type cooling method in which cooling water is used as a refrigerant has been described above by way of example.

### Embodiment 3

As illustrated in FIG. 8, a module for cooling a heating element according to an exemplary embodiment may include a flat plate-shaped heat pipe 30 including a working fluid therein, being in close contact with a heating element 11, and including a condensation region 33 not in contact with the heating element; a plurality of cooling fins 50 installed on the heat pipe; and a cooling fan 60 supplying cooling gas to the cooling fins and the condensation region.

This case is an example in which an air-cooling method using gas is applied to the cooling method. Thus, the cooling fan 60 may be provided to rotate to smoothly circulate gas emitted from a predetermined gas supply (not shown), or may be provided to generate gas in itself, but the present disclosure is not limited thereto.

In addition, an air guiding member (not shown) allowing the air cooling-type cooling method to provide relatively efficient effects may be further installed in a vicinity of the cooling fan 60, to thus induce smooth circulation of gas.

### Embodiment 4

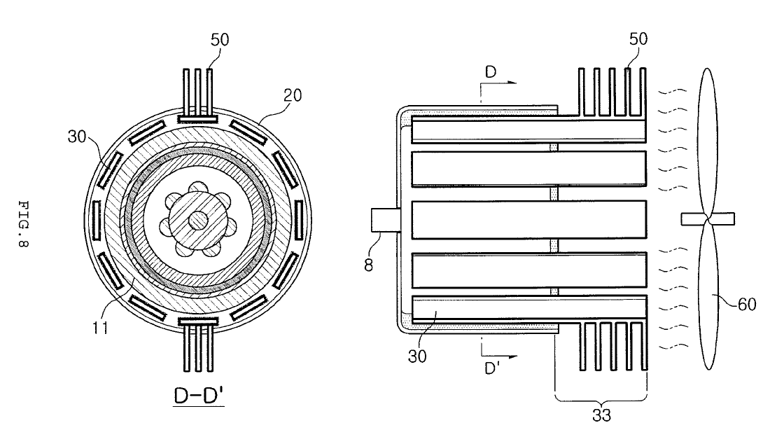

In addition thereto, as illustrated in FIG. 9, a cooling scheme, in which an impeller 61 is installed in such a manner that the refrigerant is only supplied to the condensation region 33 of the heat pipe 30, and the cooling fins 50 provided on the heat pipe 30 are cooled by air, may be selected.

Thus, the heat pipe 30 may be directly and rapidly cooled by the impeller 61 concentratedly installed in the condensation region 33 of the heat pipe 30, and cooling efficiency may be increased via heat transfer with the cooling fins 50 cooled by the air without a separate configuration. Thus, cooling efficiency of the heat pipe 30 may be further increased.

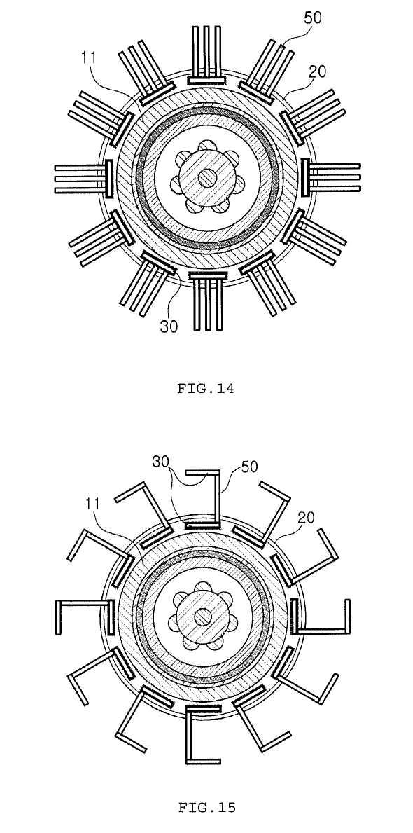

In detail, when cooling is performed by additionally installing the cooling fins 50, a plurality of cooling fins may be provided on the entirety of the heat pipe 30 as illustrated in FIGS. 11 and 14, and refrigerant gas may be supplied via the cooling fan 60. Cooling effects by convection within the heat pipe 30 may be increased, and in addition thereto, cooling effects by conduction may also be increased.

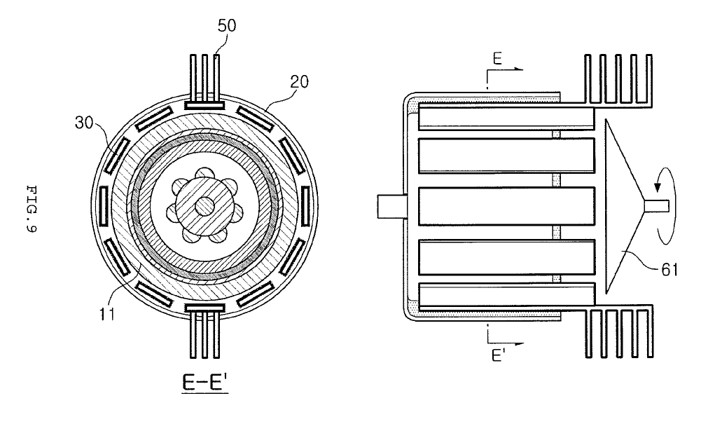

On the other hand, as a method of effectively contacting and fixing the heat pipe 30 with and to the heating element 11, for example, a method as illustrated in FIG. 10 may be used.

For example, a housing of the heating element 11 having a polygonal shape may be provided, and the heat pipes 30 may contact edges thereof, respectively. In this case, it can be easily understood by those skilled in the art that a length of one edge of the polygon corresponds to a length of the heat pipe 30, to further facilitate contact. The heat pipe 30 may be joined more firmly by using a joining member such as a strap, in addition to the configuration as described above. Thus, frequent maintenance may not be required.

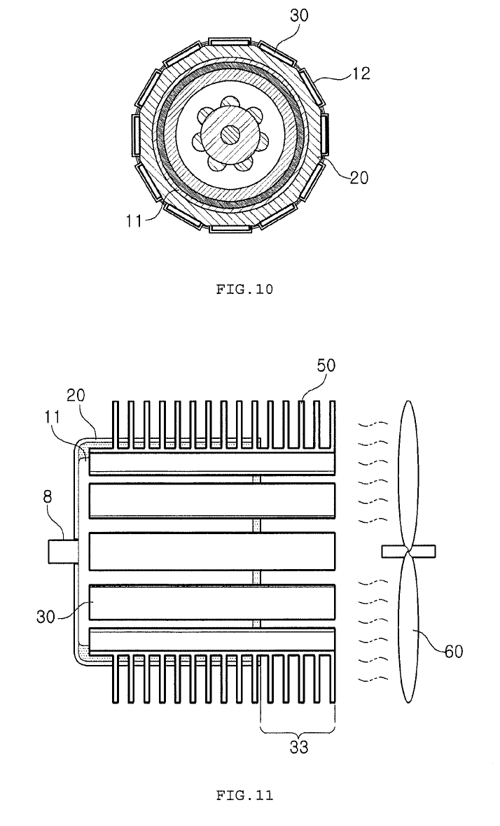

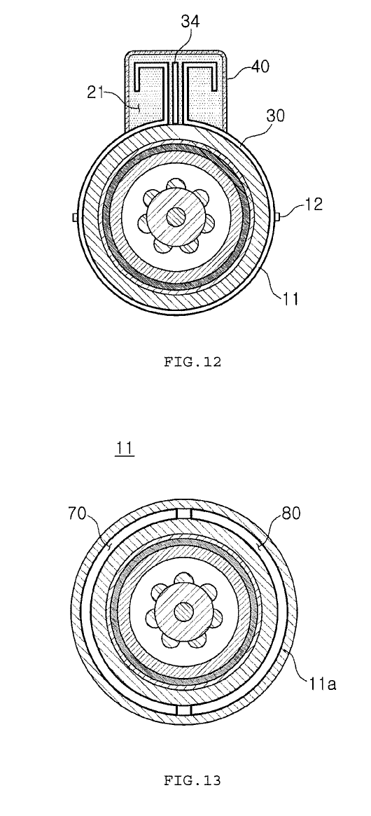

Further, by installing an additional internal heat pipe 34 in the water jacket 40 as illustrated in FIG. 12, cooling of the condensation region 33 of the heat pipe connected to the water jacket 40 may be performed more quickly. For example, in a case in which the heat pipe 30 is bent or it is difficult to form a bending portion on the heat pipe, the internal heat pipe 34 may be additionally provided as described above, thereby reducing a reduction in cooling efficiency.

In a modified embodiment, a cover housing (not shown) enclosing an outer side of the heat pipe 30 disposed to surround the heating element 11 may further be provided, and a plurality of heat pipes may be stacked on an outer side surface of the cover housing in a manner of re-surrounding the heat pipe 30. In this case, the cooling module may be deformed or adjusted according to characteristics of the heating element, thereby enhancing compatibility between the cooling module and the heating element having various characteristics.

### Embodiment 5

As illustrated in FIG. 13, in the case of a module for cooling a heating element according to an exemplary embodiment, an interior thereof may be provided as a hollow portion, and a working fluid may be circulated inside the hollow portion.

For example, the hollow portion may be configured as a heat pipe to increase spatial efficiency. Thus, as illustrated in FIG. 13, the heat pipe may include a first internal hollow portion 70 and a second internal hollow portion 80, and a working fluid may be circulated therein, which itself may perform a function of the heat pipe. However, it is to be understood that the present disclosure is not limited to the shape, number, specifications and the like of the hollow portion described.

In addition, the water jacket 40 described above may be installed to correspond to the second condensation portion 32 of the first internal hollow portion 70 and the second internal hollow portion 80 as needed, in such a manner that the exterior of the condensation portion 32 may be cooled, but the present disclosure is not limited thereto.

This exemplary embodiment provides the case in which the heat pipe 30 is embedded in the heating element 11, and in this case, the cooling module of the heating element 11 may be simplified, and the volume thereof may be reduced. Thus, spatial efficiency may be increased, and mounting of the heating element 11 may be facilitated.

### Embodiment 6

As illustrated in FIG. 15, a module for cooling a heating element according to another exemplary embodiment may be configured. In the case of the module for cooling a heating element as illustrated in FIG. 15, a cooling fin 50 may be provided, in a vertical direction, on one side of each of a plurality of heat pipes 30 provided in a housing 20 along an outer circumferential surface of the heating element 11, and another heat pipe 30 may be connected to an end of the cooling fin 50.

In this case, in which the air cooling type cooling method is used by way of example, when the plurality of heat pipes 30 and the cooling fins 50 are arranged to have a U-shape with each other, a size of the heat pipe 30 in close contact with the heating element 11 may be reduced, and there may be an effect that cooling operations may be continuously performed even in a case in which a problem such as a failure occurs in the heat pipe 30 contacting the heating element 11.

In addition, one end of the cooling fin 50 may be in contact with an evaporation portion 31 of the heat pipe 30 disposed in the housing 20, and the other end thereof may be in contact with another heat pipe 30. Thus, a cooling speed of the heat pipe 30 disposed in the housing 20 may be further increased.

On the other hand, according to another exemplary embodiment in the present disclosure, a motor may include a motor housing (not shown), a rotating shaft, a rotor, a stator and a permanent magnet provided in the motor housing, and the module for cooling a heating element as described above. In this case, the heating element is provided as the motor housing. In the case of the motor according to the exemplary embodiment, since rapid cooling may be performed in a short period of time, a lifetime of a motor and driving efficiency may be increased.

In addition, in the case of the module for cooling a heating element according to the exemplary embodiments in the present disclosure as described above, rapid cooling may be performed by closely contacting heat pipes with heating elements having various shapes, by using a flat plate-shaped heat pipe, and a motor including the flat plate-shaped heat pipe may be rapidly cooled by a flow of a working fluid inside the flat plate-shaped heat pipe attached externally. Thus, working efficiency may be increased and a service life may be increased.

While exemplary embodiments have been shown and described above, it will be apparent to those skilled in the art that modifications and variations could be made without departing from the scope of the present invention as defined by the appended claims.

1. A module for cooling a heating element, comprising:
a heat pipe having a flat plate shape, including a working fluid therein, coming into close contact with a heating element, and including a condensation region not coming into contact with the heating element; and
a cooling channel connected to the condensation region, and cooling the heat pipe by a refrigerant.

2. The module for cooling a heating element of claim 1, wherein the cooling channel is installed not to be in contact with the heating element, to be connected to the heat pipe, in a cooling region.

3. The module for cooling a heating element of claim 1, wherein the heat pipe and the heating element are provided with a heat transfer material interposed therebetween.

4. The module for cooling a heating element of claim 1, further comprising a housing surrounding an outer surface of the heating element,
wherein the heat pipe is disposed between the housing and the heating element to be closely adhered to the heating element.

5. The module for cooling a heating element of claim 1,
further comprising a cooling channel connected to the condensation region and cooling the heat pipe using a refrigerant,
wherein the heat pipe is mounted on the heating element in such a manner that the condensation region is located in a direction of gravity.

6. The module for cooling a heating element of claim 5, further comprising a plurality of side cooling channels disposed on an outer surface of the heating element in a direction perpendicular with respect to the cooling channel.

7. The module for cooling a heating element of claim 1, wherein the cooling channel is provided as a water jacket including a supply passage and a discharge passage,
the module for cooling a heating element further comprising an auxiliary cooling channel connected to the water jacket to perform heat exchange with the refrigerant.

8. The module for cooling a heating element of claim 1,
further comprising a plurality of cooling fins installed on the heat pipe; and
a cooling fan supplying cooling gas to the cooling fins and the condensation region.

9. The module for cooling a heating element of claim 1, wherein:
a housing enclosing an outer surface of the heating element or the heat pipe;
a heat pipe having a flat plate shape, including a working fluid therein, disposed between the housing and the heating element to be in contact with the heating element, and including a condensation region not in contact with the heating element;
a cooling fan supplying cooling gas to the condensation region; and
a plurality of cooling fins installed in the condensation region,
wherein the cooling pins are cooled by air.

10. The module for cooling a heating element of claim 1, wherein the heat pipe has an appearance of a shape including at least one or more corners, and has an interior provided as a hollow portion in which the working fluid is circulated.

11. The module for cooling a heating element of claim 1, wherein the cooling channel is connected to the heat pipe therein, and a refrigerant provided therein is in direct contact with the heat pipe.

12. The module for cooling a heating element of claim 10, wherein the heat pipe has a curved inner wall.

13. The module for cooling a heating element of claim 5, further comprising a cover housing surrounding an outer side of the heat pipe,
wherein a plurality of the heat pipes are stacked on an outer side of the cover housing.

14. The module for cooling a heating element of claim 9, wherein the housing has a polygonal shape, and a plurality of the heat pipes are stacked on an outer side of the housing.

15. The module for cooling a heating element of claim 7, wherein the auxiliary cooling channel comprises a radiator having an inlet and an outlet, the inlet of the radiator being connected to the discharge passage to perform heat exchange with the refrigerant, and a water pump connected to the outlet of the radiator and connected to the supply passage.

16. The module for cooling a heating element of claim 10, wherein the working fluid is provided as any one of water, acetone, methanol, ethanol, Freon, ammonia, and R134, and an interior of the heat pipe is maintained at 1 atm or lower.

17. A module for cooling a heating element, comprising:
a hollow portion provided in a hollow form of which an entrance is closed, and accommodating a working fluid therein; and
a cooling channel connected to the heating element and cooling the heating element by a refrigerant,
wherein the hollow portion is provided as a heat pipe.

18. The module for cooling a heating element of claim 17, wherein the working fluid is provided as any one of water, acetone, methanol, ethanol, Freon, ammonia, and R134, and an interior of the heat pipe is maintained at 1 atm or lower.

19. A motor comprising:
a motor housing;
a rotating shaft, a rotor, a stator and a permanent magnet provided in the motor housing; and
the module for cooling a heating element of claim 1,
wherein the heating element is the motor housing.

20. (canceled)
